(19) United States
(12) Patent Application Publication
(10) Pub. No.: US 2013/0172509 A1
(43) Pub. Date: Jul. 4, 2013

(54) Methods of Producing Microfabricated Particles for Composite Materials

(71) Applicants: Adam R. Pawloski, Lake Elmo, MN (US); Jeffrey Jacob Cernohous, Hudson, WI (US)

(72) Inventors: Adam R. Pawloski, Lake Elmo, MN (US); Jeffrey Jacob Cernohous, Hudson, WI (US)

(73) Assignee: Interfacial Solutions IP, LLC, River Falls, WI (US)

(21) Appl. No.: 13/822,165

(22) PCT Filed: Sep. 20, 2011
(86) PCT No.: PCT/US11/52370

§ 371 Date: Mar. 11, 2013

Related U.S. Application Data
(60) Provisional application No. 61/385,278, filed on Sep. 22, 2010.

(51) Int. Cl. B22F 9/04; B29B 9/10; B29B 9/02; B22F 9/06

(52) U.S. Cl. CPC B22F 9/04; B22F 9/06; B29B 9/10; B29B 9/02
USPC 528/10; 528/85; 528/322; 528/423; 528/391; 264/140; 264/141; 264/400; 164/69.1; 164/48; 29/412

(57) ABSTRACT

Microfabricated particles are dispersed throughout a matrix to create a composite. The microfabricated particles are engineered to a specific structure and composition to enhance the physical attributes of a composite material. The microfabricated particles are generated by forming a profile extrudate. A profile extrudate is an article of indefinite length that has a cross sectional profile of a desired structure with micro-scale dimensions. Upon or after formation, the profile extrudate may be divided along its length into a plurality of microfabricated particles.

### TECHNICAL FIELD

The present invention relates to the application of microfabricated particles in a matrix composition. Specifically, the present invention is a method of creating microfabricated particles of a specific engineering design for dispersion in a matrix. The microfabricated particles impart enhanced physical characteristics to the resulting composite material.

### BACKGROUND

Fiber-reinforced composite materials offer several advantages in physical properties over those of the matrix itself. Fiber reinforcement is often used to improve mechanical properties of the composite compared to the matrix alone. Mechanical strength, such as tensile, flexural, or impact strength, may be improved by the addition of fibers to the matrix, often with very favorable strength-to-weight ratios and cost benefits. One common implementation of fiber-reinforced composites is the addition of fiberglass to thermoplastic or thermoset polymers. Fibers may be made of synthetic polymers, natural polymers, metals, ceramics, inorganic materials, carbonized material, or other substances that are typically stiffer than the matrix material. Common fibers are drawn by solution or melt processing into continuous filaments, which may be further processed into thread, rope, fabric, or a weave. Fibers may be incorporated into composites using the continuous form of the fiber or by cutting the fiber down into short fiber pieces.

Alignment of fibers within the matrix has consequences on the physical properties of the composite. Fibers naturally have preferential tensile strength when strained along the long axis of the fiber. Accordingly, fiber-reinforced composites also exhibit preferential improvement in tensile strength when strained along the direction that fibers are aligned. Typically, the composite is much weaker in other directions that are not aligned with the fiber axis. Designs for composite products typically require layering fibers so that directionality of the fiber axis is varied across the layers, thus reducing the effects of anisotropy in mechanical strength. This requirement often complicates the design of products made from fiber reinforced composites and may limit the application of some materials. In addition, compressive strength of fiber-reinforced composites is typically poor because fibers may kink and buckle under compression.

### SUMMARY

There is great interest to further improve the mechanical properties of composites, particularly to address multidirectional forces applied to the composite. The composite reinforcement technology of the present invention will make use of microfabricated particles with engineered structure and composition to specifically address physical and chemical attributes of a composite material. The microfabricated particles are dispersed throughout a matrix to create the composite. For purposes of the invention, a microfabricated particle is a microfabricated object disperseable in a matrix wherein the object is of a predetermined design addressing its structure and composition. The microfabricated particle is included to impart a desired physical characteristic to the composite. The application of the microfabricated particle often results in isotropic physical enhancements in the composite. In one embodiment, the microfabricated particles of the invention are referred to as eligotropic, meaning that directional characteristics of the particles are selected to impart desired properties to a matrix or composite material that include the particles.

Microfabrication technology may be used to fabricate the particles that will allow for tremendous accuracy, precision, consistent replication, and flexibility in their construction on a micrometer scale or smaller. Microfabrication means that the particles are created as a multitude of objects of predetermined micro-scale dimensions in a combined manner to form an article. Each of the micro-scale objects are releasable from the article. For purposes of the invention, releasable may indicate some form of partitioning. In one embodiment, the article is well suited for various separation practices that result in the release of individual objects from the article. For purposes of the invention, “microfabrication” expressly excludes naturally occurring materials, solution phase created materials, and vapor phase created materials. The term “microfabricated” refers to particles that have been formed by microfabrication as defined herein.

In one embodiment of the present invention, microfabricated particles may be fabricated from a profile extrudate. A profile extrudate is an article of indefinite length that has a cross sectional profile of a desired structure with micro-scale dimensions. The profile extrudate may be formed various materials that are suitable for conventional processing from a melt, drawn or flowable state. For example, the profile extrudate may be a metal, a metal alloy, a thermoset polymer, a thermoplastic polymer, a polymer composite, gels, glass, or ceramic material. In general, the materials are processed with a forming mechanism, such as a die, to create an article of indefinite length that has a desired cross sectional profile.

Upon or after formation, the profile extrudate may be divided along its length into a plurality of microfabricated particles. There are multiple mechanisms available for dividing the profile extrudate into microfabricated particles.

After fabrication, microfabricated particles, formed from a profile extrudate, may be mixed into a matrix to produce reinforced composites. Additionally, one may construct microfabricated particles with multifunctional attributes or mix different microfabricated particles into the same matrix for different effects.

The above summary of the present invention is not intended to describe each disclosed embodiment or every implementation of the preset invention. The detailed description that follows more particularly exemplifies illustrative embodiments.

### BRIEF DESCRIPTION OF DRAWINGS

FIG. 1 is an image of a matrix embodying microfabricated particles at fifty times magnification;

FIG. 2 depicts various structures exemplifying microfabricated particles of the present invention;

FIG. 3 is a segmented isometric view of a profile extrudate; and

FIG. 4 depicts a microfabricated particle after it is divided from a profile extrudate.

### DETAILED DESCRIPTION

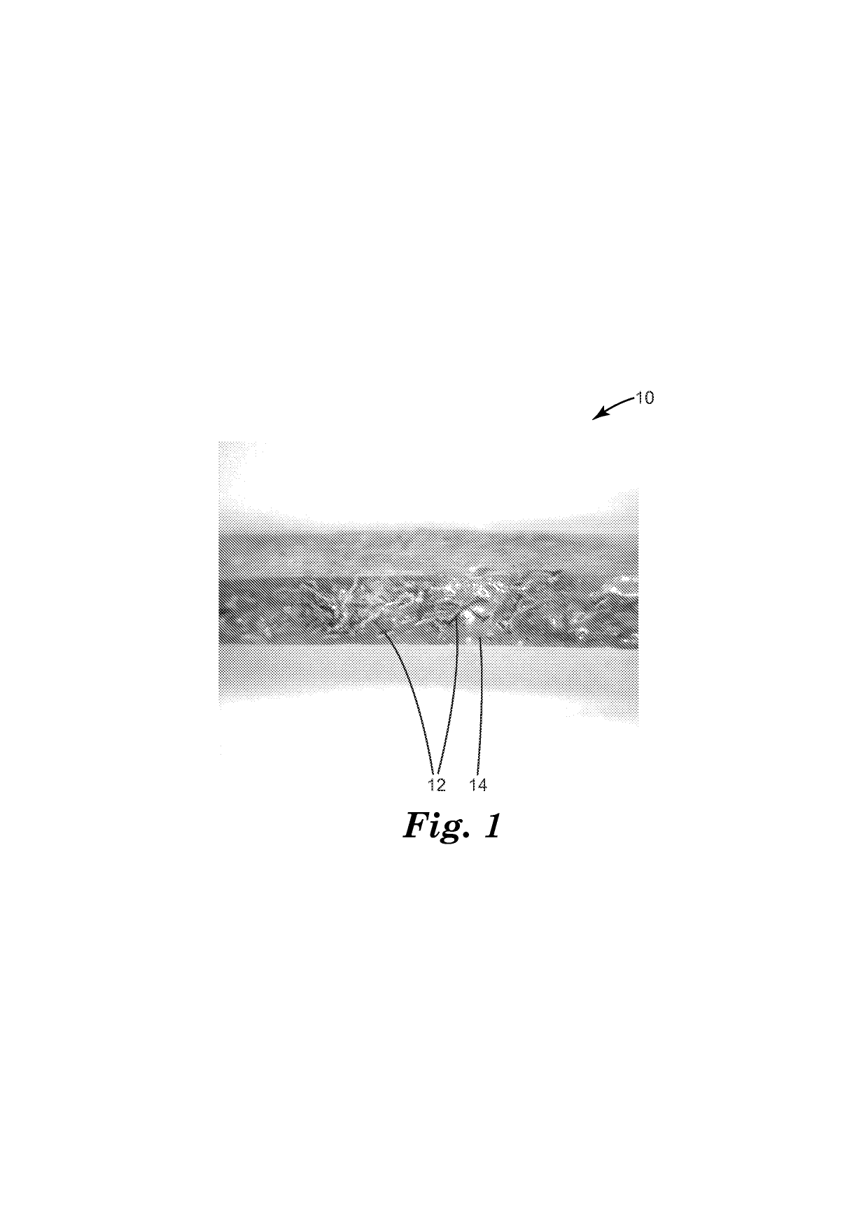

The composite reinforcement technology of the present invention encompasses microfabricated particles dispersed throughout a matrix. A microfabricated particle is a microfabricated object disperseable in a matrix wherein the object is of a predetermined design encompassing structure and composition. The microfabricated particle is included to impart a desired physical characteristic to the resulting composite. In one embodiment, the microfabricated particles are eligotropic, meaning that directional characteristics of the particles are selected to impart desired properties to a matrix or composite material that include the particles. FIG. 1 is an image that depicts the general application of composite 10 comprising microfabricated particles 12 dispersed throughout a polymeric matrix 14.

The matrix of the present invention may include various materials that can accept microfabricated particles. For example, the matrix may include polymeric materials, ceramic materials, cementitious materials, metals, alloys or combinations thereof. In certain embodiments, the matrix is one or more of a thermoset polymer or a thermoplastic polymer. In one embodiment, the matrix may include polymers selected from aromatic polyamide (aramid), ultra-high molecular weight polyethylene (UHMWPE), poly-p-phenylenebenzobisoxazole (PBO), polyethylene, polystyrene, polymethylmethacrylate (PMMA), polyacrylate, polyphenylene sulfide (PPS), polyphenylene oxide (PPO), polypropylene, polyaryletheretherketone (PEEK), nylon, polyvinylchloride (PVC), acrylonitrile butadiene styrene (ABS), polycarbonate (PC), polyethylene terephthalate (PET), polylactic acid (PLA), polybutylene terephthalate (PBT) or combinations thereof. Additional non-limiting examples of thermoset polymers suitable for use in the present invention include epoxies, urethanes, silicone rubbers, vulcanized rubbers, polyimide, melamine-formaldehyde resins, urea-formaldehyde resins, and phenol-formaldehyde resins. The matrix may include a range from about 10 to about 99 weight percent of the composite.

According to the present invention, the microfabricated particle is added to the matrix to develop the composite. The microfabricated particle is constructed from one or more materials using microfabrication practices detailed further below in this description. The one or more materials may include polymeric materials (thermoset or thermoplastic), polymer composites, gels, metals, semiconductors, glass, ceramic, inorganic films, or combinations thereof. Metals or metal alloys, may include, for example, aluminum, steel, lead, indium, platinum, silicon, zirconium, gold, silver, hafnium, berrylium, molybdenum, tantalum, vanadium, rhenium, niobium, columbium, copper, nickel, titanium, tungsten, magnesium, zinc, or tin.

Non-limiting examples of thermoplastic polymers may include polyolefins, polyesters, aromatic polyamides (aramid), poly-p-phenylenebenzobisoxazole (PBO), polystyrene, polymethylmethacrylate (PMMA), polyacrylate, polyphenylene sulfide (PPS), polyphenylene oxide (PPO), polypropylene, polyaryletheretherketone (PEEK), polyvinylchloride (PVC), polyacetal (POM), fluoroplastics, liquid crystal polymer, acrylonitrile butadiene styrene (ABS), polycarbonate (PC), polyethylene terephthalate (PET), polybutylene terephthalate (PBT), polylactic acid, polyimide, polyamide, polysulfone, polyethersulfone, polyphenyl sulfone, or combinations thereof. In another embodiment, the polymeric based microfabricated particle is a thermoset polymer. Thermoset polymers may include the following non-limiting examples; polyurethanes, silicon elastomers, polyimides, polycyanurates, melamine resins, fluoroelastomers, or combinations thereof.

The structure, size, porosity, or surface characteristics of the microfabricated particle may all vary in order to achieve desirable physical characteristics in the resulting composite. Additionally, the microfabricated particles may be designed to interact with each other, thereby further enhancing the physical characteristics of the composite. Mechanical, electrical or chemical interaction are three exemplary forms of such interaction. Specific non-limiting examples include (i) comb-like microfabricated particles having at least some tines that mesh with each other in the composite, (ii) microfabricated particles capable of self-assembly into cooperative structures or networks, (iii) chemical surface modification of the microfabricated particles that may include hydrophilic or hydrophobic construction or treatment of the particles, and (iv) integration of magnetic or electrically active materials into the microfabricated particles. In one embodiment, the microfabricated particles have a general size ranging from 0.1 to 5000 microns. The microfabricated particles are generally added to the matrix in an amount ranging from about greater than zero to about 80 weight percent.

The microfabricated particle may be designed or selected to impart various desirable properties to the resulting composite. For example, thermal properties, mechanical properties, electrical properties, chemical properties, magnetic properties, or combinations thereof may all be beneficially affected by the inclusion of a microfabricated particle in the matrix.

Structured microfabricated particles may be designed to improve particular mechanical properties. For example, to improve the elastic properties of a material, one of ordinary skill in the art may consider incorporating microfabricated particles with spring-like or coiled structures that elongate under stress. Of particular interest to armor applications is the ability to dampen and dissipate impact forces along a dimensional axis and from particle to particle within the composite. One embodiment may include collapsible structures that crush under impact, absorbing energy from collision. Although strong under tensile deformation, conventional fiber reinforced composites often fail under compression due to kinking. Microfabricated particles designed with cross structures could impart increased stiffness in the axis perpendicular to fiber alignment, thus improving compressive strength.

Auxetic structures are a form of microfabricated particles capable of improving impact resistance. An auxetic material exhibits the unusual behavior of a negative Poisson's ratio. Under such behavior, the cross-section of the material increases as the material is deformed under a tensile load. This unusual behavior is of significant interest to high impact strength applications because it represents a path by which energy may be dissipated between particles and in the direction perpendicular to the primary axis.

Certain embodiments may include structures that work in combination with the matrix to enable uniform electrical or thermal properties of the composite. For example, a matrix may contain microfabricated particles comprising electrically or thermally conductive materials shaped to provide multidirectional reinforcement, modification or conductivity.

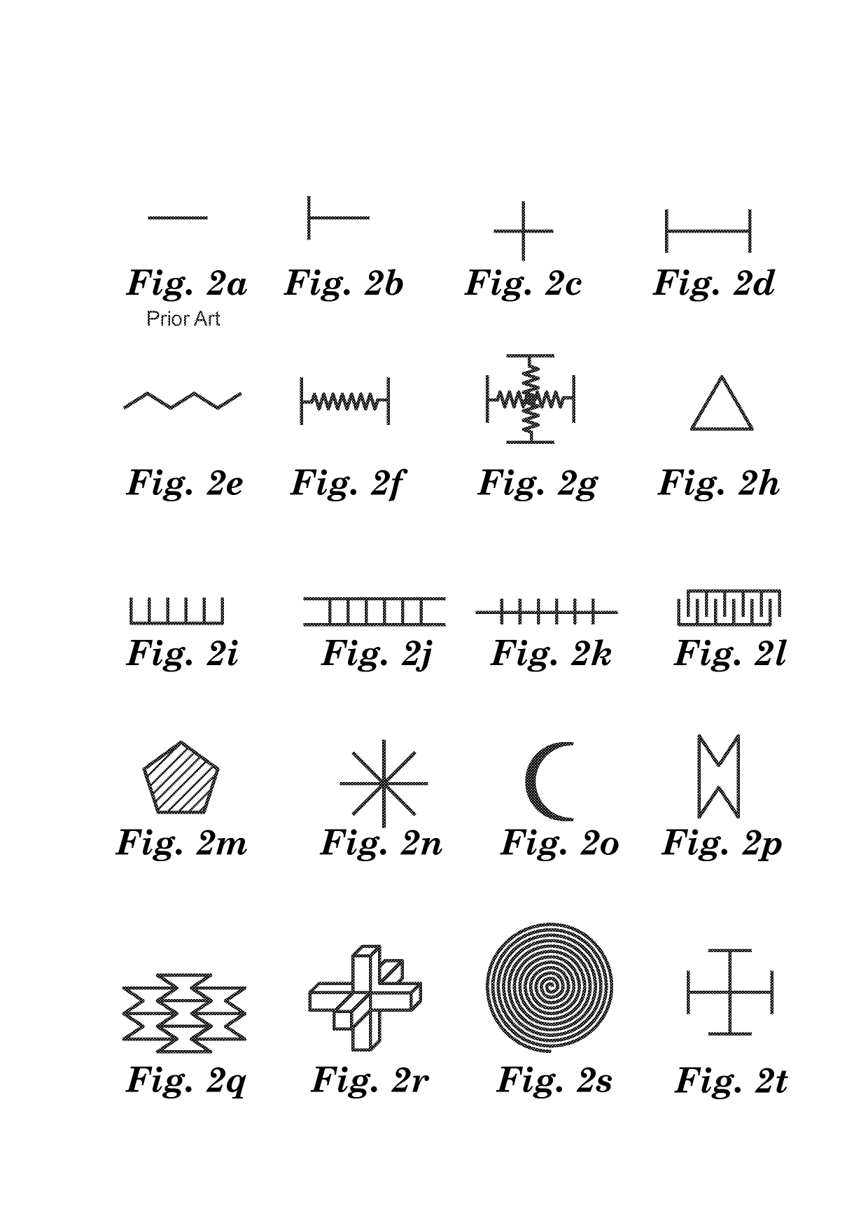

FIG. 2(a) is an illustration of standard fibers or filament articles that are conventionally employed as fillers in polymeric matrices. Typically, structures such as FIG. 2(a) offer anisotropic properties. FIGS. 2(b)-(t) depict several non-limiting examples of microfabricated particles suitable for applications within the context of the present invention. The embodiments of FIG. 2(b)-(t) through 2(r) are all embodiments that can enhance or improve physical characteristics in selected matrix applications. The specific structures are described as follows: FIG. 2(a) prior art fiber, FIG. 2(b) tee, FIG. 2(c) cross, FIG. 2(d) I-beam, FIG. 2(e) askew, FIG. 2(f) spring, FIG. 2(g) two dimensional spring, FIG. 2(h) open polygon, FIG. 2(i) comb, FIG. 2(j) ladder structure, FIG. 2(k) branched or segmented structure, FIG. 2(l) interlocking structures, FIG. 2(m) filled polygon, FIG. 2(n) starburst, FIG. 2(o) crescent, FIG. 2(p) auxetic structure, FIG. 2(q) auxetic network, FIG. 2(r) three dimensional crossbar, FIG. 2(s) spiral structures, and FIG. 2(t) T-headed cross. Those of ordinary skill in the art are capable of selecting one or more structures to achieve a desired end property for the resulting composite material.

In an alternative embodiment, the microfabricated particle may be designed to include auxiliary items such as, for example, sensors, encapsulated materials, release structures, electronics, tagants, optical components, or combinations thereof.

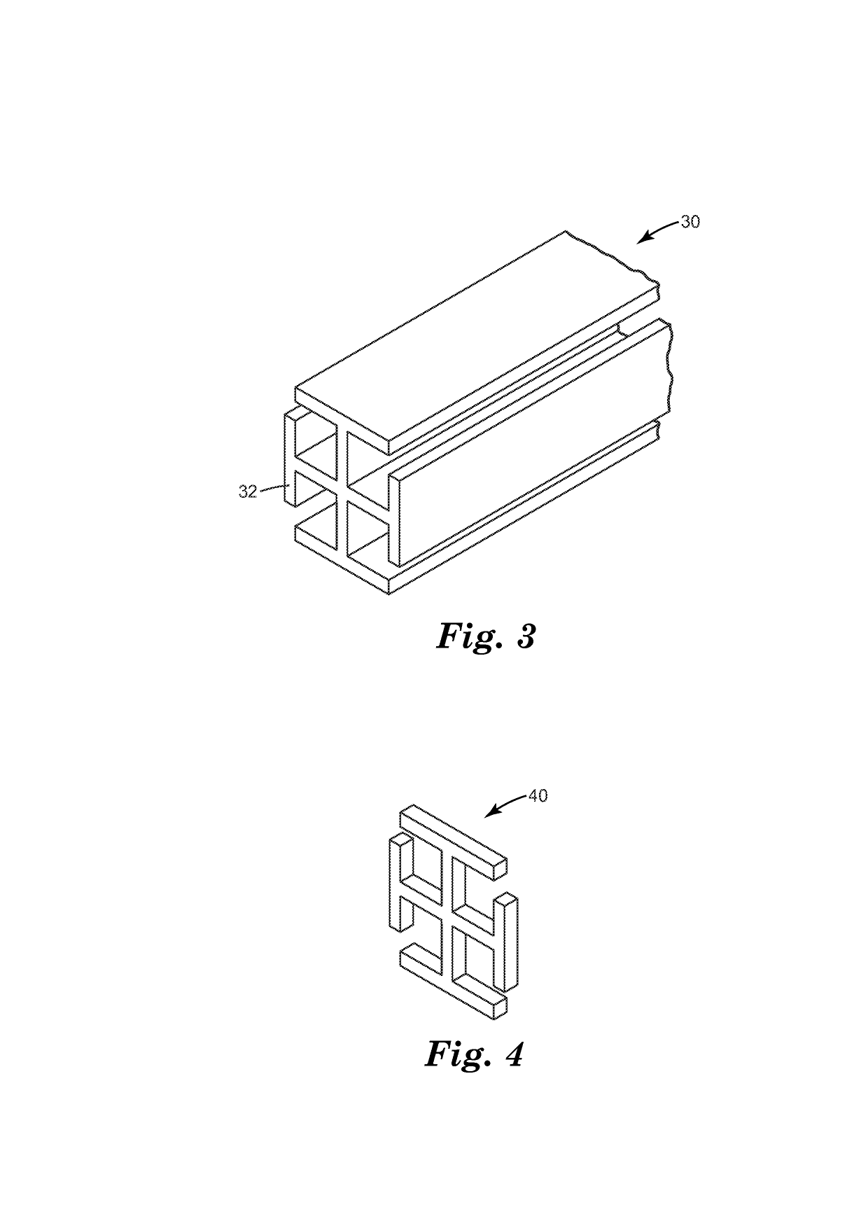

Manufacturing of the microfabricated particles may be accomplished through the formation of a profile extrudate. A profile extrudate is an article of indefinite length that has a cross sectional profile of a desired structure with micro-scale dimensions. The profile extrudate may be formed various materials that are suitable for conventional processing from a melt, drawn or flowable state. For example, the profile extrudate may be a metal, a metal alloy, a thermoset polymer, a thermoplastic polymer, a polymer composite, gels, glass, or ceramic material. In general, the materials are processed through a forming mechanism, such as a die, to create an article of indefinite length that has a desired cross sectional profile. The formation of the profile extrudate may include extrusion, pultrusion, casting, molding or milling techniques. A profile extrudate is illustrated in FIG. 3. The extrudate 30 has a profile 32 in the shape of a t-headed cross.

Upon or after formation, the profile extrudate may be divided along its length into a plurality of microfabricated particles. There are multiple mechanisms available for dividing the profile extrudate into microfabricated particles. Methods for dividing the profile extrudate may include mechanical cutting, laser cutting, water jet cutting, plasma cutting, wire electrical discharge machining, and milling. Example of mechanical cutting include sawing, dicing and pelletizing. Those of ordinary skill in the art are capable of selecting an appropriate method for dividing the profile extrudate based upon the material of the extrudate and the structure of the profile. The dividing of the profile extrudate may occur immediately upon formation, subsequent to the formation, or even prior to insertion of the microfabricated particles into melt processing equipment. FIG. 4 depicts a microfabricated particle 40 after it is divided from a profile extrudate, such as that shown in FIG. 3.

After creation of the microfabricated particles, the particles may be further conditioned prior to their intended application in various composite materials. Conditioning may include drying, curing, developing, washing, coating, surface treating, dissolving or combinations thereof. Those of ordinary skill in the art are capable of selecting the appropriate conditioning steps to address the selected materials used to form the microfabricated particles.

Conventional composite generation processes may be utilized to disperse one or more forms of microfabricated particles within a matrix. Suitable processes may include, for example, solution mixing, extrusion, injection molding, melt mixing, dry mixing, casting, or fiber spinning. Those skilled in the art are capable of selecting an appropriate process depending upon materials and end use applications.

Microfabricated particles may be further modified on their surfaces after construction by conventional processes. Surface modification techniques, such as silanation, are well known methods for controlling the interfacial bonding between dissimilar materials for the purposes of promoting compatibilization. In one embodiment, the surface modification layer is deposited onto at least a portion of the surface of the microfabricated particle by silanation. The silanation may occur in a suspension of microfabricated particles. In another embodiment, the silanation process is applied from a liquid brought into contact with the microfabricated particles. Those of ordinary skill in the art are capable of identifying appropriate surface modifiers to address an intended application.

Conventionally recognized additives may also be included in the composite material. Non-limiting examples of conventional additives include antioxidants, light stabilizers, fibers, fillers, blowing agents, foaming additives, antiblocking agents, heat stabilizers, impact modifiers, biocides, plasticizers, tackifiers, colorants, processing aids, desiccants, lubricants, coupling agents, and pigments. In an alternative embodiment, compatiblizing agents may be added to the composite or combined with the microfabricated particle. The additives may be incorporated into the composition in the form of powders, pellets, granules, or in any other form. The amount and type of conventional additives in the composition may vary depending upon the matrix and the desired physical properties of the finished composition. In one embodiment the microfabricated particles may interact with one or more of the fillers and additives present in the matrix. Those skilled in the art are capable of selecting appropriate amounts and types of additives to match with a specific matrix in order to achieve desired physical properties of the finished material.

The resulting articles produced by the inventive composite exhibit improved physical characteristics. Such physical characteristics may include modulus, strength, toughness, elongation, impact resistance, reduction of anisotropy, thermal conductivity, electrical conductivity or combinations thereof.

The composites created through the utilization of the microfabricated particles may be employed in various applications and industries. For example, the composites of this invention are suitable for manufacturing articles in the construction, electronics, medical, aerospace, consumer goods and automotive industries. Articles incorporating the microfabricated particles may include: molded architectural products, forms, automotive parts, building components, household articles, biomedical devices, aerospace components, or electronic hard goods.

### EXAMPLES

### Example 1

### Construction and Division of a Profile Extrudate (Metallic)

An extruded profile in the shape of a T-headed cross was toll produced by a contract manufacturer, Argyle Industries, Inc of Branchburg, N.J. A die suitable for creating a T-headed cross was fabricated and used to shape the extrudate in a commercial aluminum extrusion process. The largest width of the T-headed cross profile was 3.8 mm and the narrowest dimension of the profile was 0.64 mm. Extruded profiles were produced from 6063-T5 aluminum alloy and cut to six-foot lengths. The profile extrusions were cut in 1 mm thick particles using a CNC swiss style cutting machine

### Example 2

### Construction of a Profile Extrudate (Polymeric)

A polysulfone (Udel P1700 from Solvay Advanced Polymers, Alpharetta, Ga.) was volumetrically fed into the feed zone of a 27 mm co-rotating twin screw extruder (American Leistritz Extruder Corporation, Sommerville, N.J.) fitted with a T-headed cross die. The largest width of the T-headed cross profile was 3.8 mm and the narrowest dimension of the profile was 0.64 mm. The material was processed at 85 rpm screw speed at 280° C. The feed rate was monitored by maintaining the screw torque between 50-65%. The strands of the profile extrudate having a T-headed cross profile emerged from the die and were pulled forward using a small moving belt conveyor.

### Example 3

### Dividing a Profile Extrudate into Microfabricated Particles

The collected T-headed cross strands of the profile extrudate produced from Example 2 were manually fed through a Labtech Sidecut Pelletizer with a pull rate 33.4 ft/min and 0.4 mm thickness. The resulting microfabricated particles were collected.

### Example 4

### Composite Fabrication

A dry blend comprising 60 grams (20 wt %) of microfabricated particles produced from Example 3 and 140 grams (80 wt %) of a polyolefin elastomer (Engage 8003 from Dow Chemical, Midland, Mich.) was produced as feed for a melt mixing operation. The blend was fed into a mixing bowl attachment on a ¾″ single screw extruder (CW Brabender, Hackensack, N.J.) and mixed for four minutes a temperature of 140° C. After four minutes of mixing, the Brabender was stopped and the face plate was removed. The screw was pulled and the resulting mixed sample was removed from the bowl. Approximately 75 grams of the melt blended sample was pressed into a 15.25 cm×15.25 cm sheet, 0.3 cm thick using a heated hydraulic press (Dake, Grand Haven, Mich.) for five minutes at 5 tons of pressure and heated to 160° C.

From the above disclosure of the general principles of the present invention and the preceding detailed description, those skilled in this art will readily comprehend the various modifications to which the present invention is susceptible. Therefore, the scope of the invention should be limited only by the following claims and equivalents thereof.

What is claimed is:

1. A method comprising dividing a profile extrudate into a plurality of microfabricated particles.

2. A method according to claim 1, wherein the profile extrudate is a metal, a metal alloy, a thermoset polymer, a thermoplastic polymer, a polymer composite, gels, glass, or ceramic.

3. A method according to claim 1, wherein dividing includes mechanical cutting, laser cutting, water jet cutting, and plasma cutting.

4. A method according to claim 1, wherein the profile extrudate has a cross sectional profile of a tee, cross, I-beam, askew, spring, two dimensional spring, open polygon, comb, ladder structure, branched structure, segmented structure, interlocking structure, filled polygon, starburst, crescent, auxetic structure, auxetic network, three dimensional crossbar, spiral structures, and T-headed cross.

5. A method according to claim 1, wherein the microfabricated particle is constructed from one or more materials or includes one or more structures.

6. A method according to claim 1, further comprising conditioning the microfabricated particles.

7. A method according to claim 6, wherein the conditioning includes drying, curing, developing, coating, surface treating, dissolving, washing or combinations thereof.

8. A method according to claim 2, wherein the metal or metal alloy includes aluminum, steel, lead, indium, platinum, silicon, zirconium, gold, silver, hafnium, berrylium, molybdenum, tantalum, vanadium, rhenium, niobium, columbium, copper, nickel, titanium, tungsten, magnesium, zinc, or tin.

9. A method according to claim 2, wherein the thermoset polymer includes polyurethanes, silicon elastomers, polyimides, polycyanurates, melamine resins, fluoroelastomers, or combinations thereof.

10. A method according to claim 2, wherein the thermoplastic polymer includes polyolefins, polyesters, aromatic polyamides, poly-p-phenylenebenzobisoxazole, polystyrene, polymethylmethacrylate, polyacrylate, polyphenylene sulfide, polyphenylene oxide, polypropylene, polyaryletheretherketone, polyvinylchloride, polyacetal, fluoroplastics, liquid crystal polymer, acrylonitrile butadiene styrene, polycarbonate, polyethylene terephthalate, polylactic acid, polyimide, polyamide, polysulfone, polyethersulfone, polyphenyl sulfone, polylactic acid, or combinations thereof.

11. A method according to claim 1, wherein the dividing occurs immediately prior to insertion of the microfabricated particles into melt processing equipment.

12. A method comprising,
(a) forming a profile extrudate
(b) dividing the profile extrudate into a plurality of microfabricated particles, and
(c) collecting the microfabricated particles.

13. A method according to claim 12, wherein forming the profile extrudate includes extrusion, pultrusion, casting, molding or milling.

14. A method according to claim 12, wherein the profile extrudate is a metal, a metal alloy, a thermoset polymer, a thermoplastic polymer, a polymer composite, gels, glass, or ceramic.

15. A method according to claim 12, wherein dividing includes mechanical cutting, laser cutting, pelletizing, or milling.
